(19) United States
(12) Patent Application Publication
(10) Pub. No.: US 2017/0165596 A1
(43) Pub. Date: Jun. 15, 2017

(54) BAG FILTER ASSEMBLY

(71) Applicant: Parker-Hannifin Corporation, Cleveland, OH (US)

(72) Inventors: Ronald FALL, Carmel, IN (US); William T. CLEMONS, Leitchfield, KY (US)

(21) Appl. No.: 15/325,531

(22) PCT Filed: Jul. 29, 2015
(86) PCT No.: PCT/US2015/042644

§ 371 Date: Jan. 11, 2017

Related U.S. Application Data
(60) Provisional application No. 62/031,319, filed on Jul. 31, 2014.
(60) Provisional application No. 62/073,433, filed on Oct. 31, 2014.

(51) Int. Cl. B01D 29/27; B01D 35/153; A47L 13/58

(52) U.S. Cl. CPC B01D 29/27; A47L 13/58; B01D 35/153; B01D 2201/301

(57) ABSTRACT

A filter connectable to a filter housing assembly. When the filter is disconnected from the filter housing assembly, a driven cover of the filter housing assembly is in a closed position preventing unfiltered fluid from flowing through an inlet of the assembly. When the filter is connected to the filter housing assembly, a filter bag ring of the filter moves the driven cover to an open position uncovering the inlet allowing filtered fluid to flow through the inlet.

### RELATED APPLICATION DATA

This application claims the benefit of U.S. Provisional Applications Nos. 62/031,319 filed Jul. 31, 2014 and 62/073,433 filed Oct. 31, 2014, all of which are incorporated herein by reference.

### FIELD OF INVENTION

The present invention relates generally to a bag filter assembly, and more particularly to a process fluid bag filter assembly for a gravity flow application.

### BACKGROUND

In mop buckets that are not compartmentalized, the initially clean wash liquid becomes dirty and contaminated each time the dirty mop or other cleaning device is squeezed or wrung to discharge its dirty wash liquid load. In mop bucks that are compartmentalized, the mop buckets include separate reservoirs for segregating clean wash liquid, such as water, from dirty or contaminated wash liquid. The compartmentalized bucket may also contain a discharge transfer compartment for wringing a mop and providing for the transfer of its discharge to a discharge storage reservoir by way of holes in the floor connecting the discharge transfer compartment and said reservoir.

### SUMMARY OF INVENTION

The present invention provides a filter connectable to a filter housing assembly. When the filter is disconnected from the filter housing assembly, a driven cover of the filter housing assembly is in a closed position preventing unfiltered fluid from flowing through an inlet of the assembly. When the filter is connected to the filter housing assembly, a filter bag ring of the filter moves the driven cover to an open position uncovering the inlet allowing filtered fluid to flow through the inlet.

According to one aspect of the invention, a filter assembly is provided that includes a filter and a filter housing assembly. The filter includes a filter media circumscribing a central axis and having a closed end and an open end, and a filter media ring attached to the filter media at the open end, the filter media ring including a central body portion having a first axial side, a second axial side opposite the first axial side, and an opening extending therethrough, at least one tab projecting radially outwardly from the central body portion, and at least one axially opening recess in the first axial side. The filter housing includes a housing having an inlet opening to a mounting face and an outlet in fluidic communication with the inlet, a media ring retainer on the housing including a circumferential ledge for axially retaining the at least one tab of the filter media ring, and at least one opening in the ledge for allowing axial insertion of the at least one tab into the ledge after which the filter media ring is rotatable relative to the media ring retainer for locking the filter media ring to the media ring retainer, and a driven cover attached to the housing at the mounting face for movement relative to the housing between a closed position covering the inlet of the housing and an open position uncovering the inlet to allow flow into the inlet, the driven cover including a central body portion and at least one tab projecting radially outwardly from the central body portion for mating with the at least one axially opening recess of the filter media ring to be moved by the filter media ring between the open and closed positions.

According to another aspect of the invention, a filter housing assembly is provided that is connectable to a filter that includes a filter media and a filter media ring attached to the filter media, the filter media ring having at least one radially outwardly projecting tab and at least one axially opening recess. The filter housing assembly includes a housing have an inlet opening to a mounting face and an outlet in fluidic communication with the inlet, a media ring retainer on the housing including a circumferential ledge for axially retaining the at least one tab of the filter media ring and at least one opening in the ledge for allowing axial insertion of the at least one tab into the ledge after which the media ring is rotatable relative to the retainer for locking the media ring to the retainer, and a driven cover attached to the housing at the mounting face for movement relative to the housing between a closed position covering the inlet of the housing and an open position uncovering the inlet to allow flow into the inlet, the driven cover including a central body portion and at least one tab projecting radially outwardly from the central body portion for mating with the at least one recess of the filter media ring.

According to yet another aspect of the invention, a filter for use in a filter assembly is provided that includes a filter media circumscribing a central axis and having a closed end and an open end, and a filter media ring attached to the filter media at the open end, the filter media ring including a central body portion having a first axial side, a second axial side opposite the first axial side, and an opening extending therethrough from the first axial side to the second axial side, at least one tab projecting radially outwardly from the central body portion and having a circumferential length less than a circumferential length of a periphery of the central body portion, and at least one axially opening recess in the first axial side for engaging a tab of a driven cover to move the driven cover to an open position allowing fluid flow through the filter assembly.

According to still another aspect of the invention, a method of installing a filter on a filter housing assembly is provided, the filter including a filter bag and a filter bag ring attached to an open end of the filter bag, and the filter housing assembly including a housing having an inlet, a bag retainer attached to the housing, a driven cover attached to the housing for movement relative to the housing, and a support core attached to the housing. The method includes advancing the open end of the filter bag over the support core, aligning a plurality of circumferentially spaced tabs of the filter bag ring with a plurality of circumferentially spaced openings in a circumferential ledge of the bag ring retainer, advancing the plurality of circumferentially spaced tabs through the plurality of circumferentially spaced openings, and rotating the filter to a locked position thereby moving the driven cover to an open position to uncover the inlet in the housing to allow fluid flow through the inlet.

According to a further aspect of the invention, a filter for use in a filter assembly is provided that includes a cylindrical ring with inner and outer cylindrical surfaces extending between first and second axial end faces, a plurality of circumferentially spaced tabs projecting radially outwardly from the outer cylindrical surface proximate the first axial end face, and a plurality of circumferentially spaced notches in the first axial end face, and a filter bag attached to the cylindrical ring and extending from the second axial end face.

According to another aspect of the invention, a filter housing assembly is provided that includes a housing having a passage, a bayonet ring defining a ledge and having at least one groove for axially receiving a tab of a filter bag ring to allow for insertion of the tab and rotation of the tab underneath the ledge, and a valve member having a coupling feature for coupling with a mating coupling feature on the filter bag ring such that rotation of the filter bag ring causes rotation of the valve member, wherein the valve member is rotatable between an open position allowing flow through the passage in the housing and a closed position blocking flow to the passage.

The foregoing and other features of the invention are hereinafter described in greater detail with reference to the accompanying drawings.

### BRIEF DESCRIPTION OF THE DRAWINGS

FIG. 1 is a perspective view of an exemplary filter assembly according to the invention.

FIG. 2 is a side view of the filter assembly.

FIG. 3 is a front perspective view of an exemplary filter housing assembly of the filter assembly.

FIG. 4 is a rear perspective view of the filter housing assembly

FIG. 5 is a side view of the filter housing assembly.

FIG. 6 is a cross-sectional view of the filter housing assembly taken about line 6-6 in FIG. 5.

FIG. 7 is a perspective exploded view of the filter housing assembly.

FIG. 8 is a side exploded view of the filter housing assembly.

FIG. 9 is an exploded view of components of the filter assembly.

FIG. 10 is an end view of a handle of the filter housing assembly.

FIG. 11 is a front view of a driven cover of the filter housing assembly.

FIG. 12 is a front perspective view of the driven cover.

FIG. 13 is a cross-sectional view of the driven cover taken about line 13-13 in FIG. 11.

FIG. 14 is a rear view of the driven cover.

FIG. 15 is a rear perspective view of the driven cover.

FIG. 16 is a cross-sectional view of the driven cover taken about line 16-16 in FIG. 11.

FIG. 17 is an end view of a bag ring retainer of the filter housing assembly.

FIG. 18 is a cross-sectional view of the bag ring retainer taken about line 18-18 in FIG. 17.

FIG. 19 is a side view of a support core of the filter housing assembly.

FIG. 20 is an end view of the support core.

FIG. 21 is a side view of an end plug that is received in the support core.

FIG. 22 is a cross-sectional view of the end plug taken about line 22-22 in FIG. 21.

FIG. 23 is a perspective view of an exemplary filter of the filter assembly.

FIG. 24 is a side view of a bag ring of the filter.

FIG. 25 is a rear view of the bag ring.

FIG. 26 is a cross-sectional view of the bag ring taken about line 26-26 in FIG. 25.

### DETAILED DESCRIPTION

The principles of this present invention have particular application to filter assemblies for mop buckets, and thus will be described below chiefly in this context. It will of course be appreciated, and also understood, that principles of this invention may be applicable to other filter assemblies where it is desirable to remove particulates from a liquid.

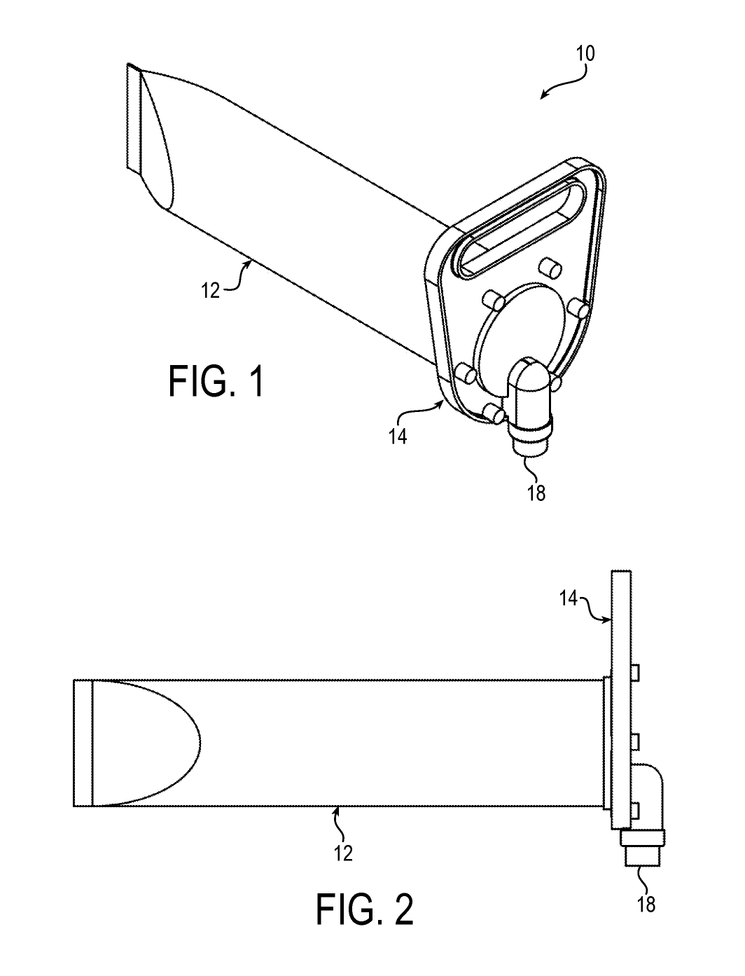

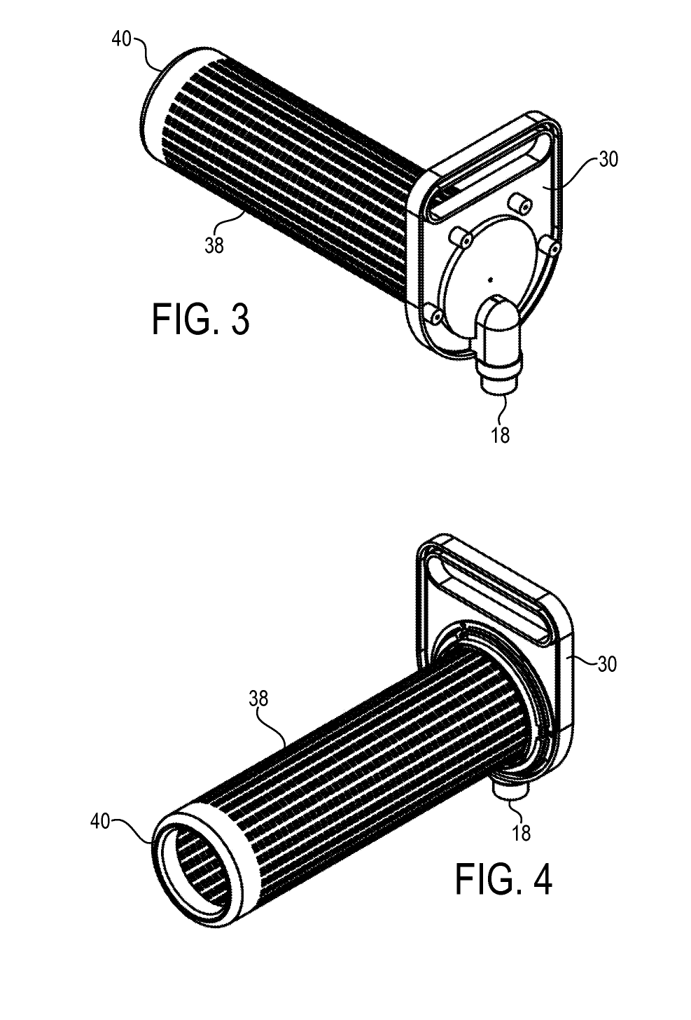

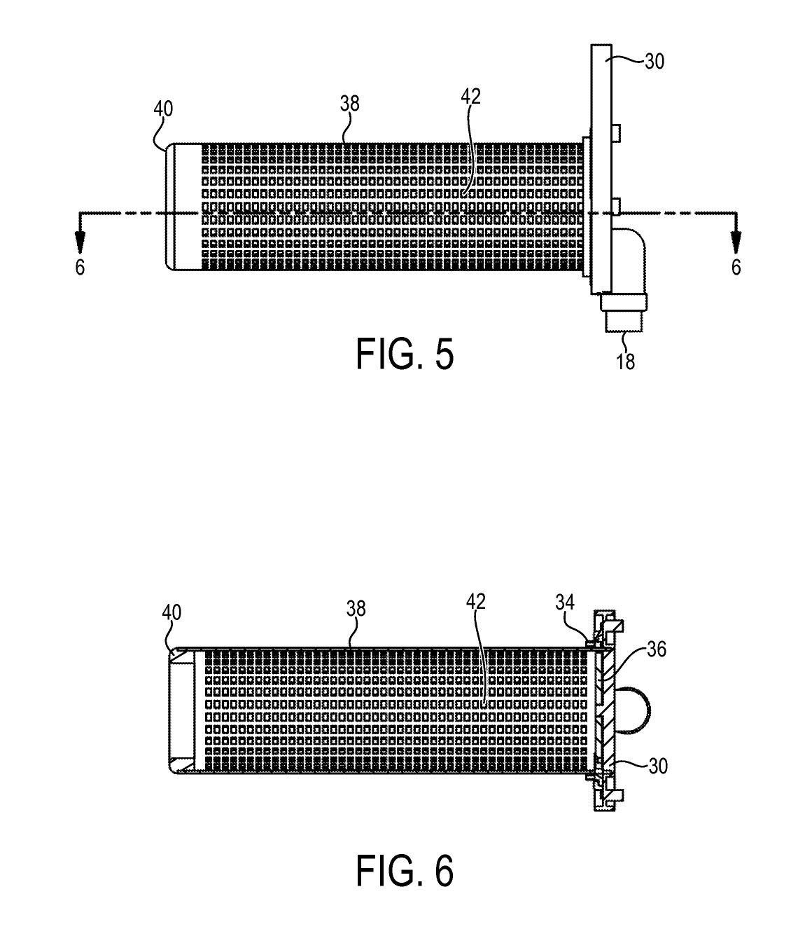

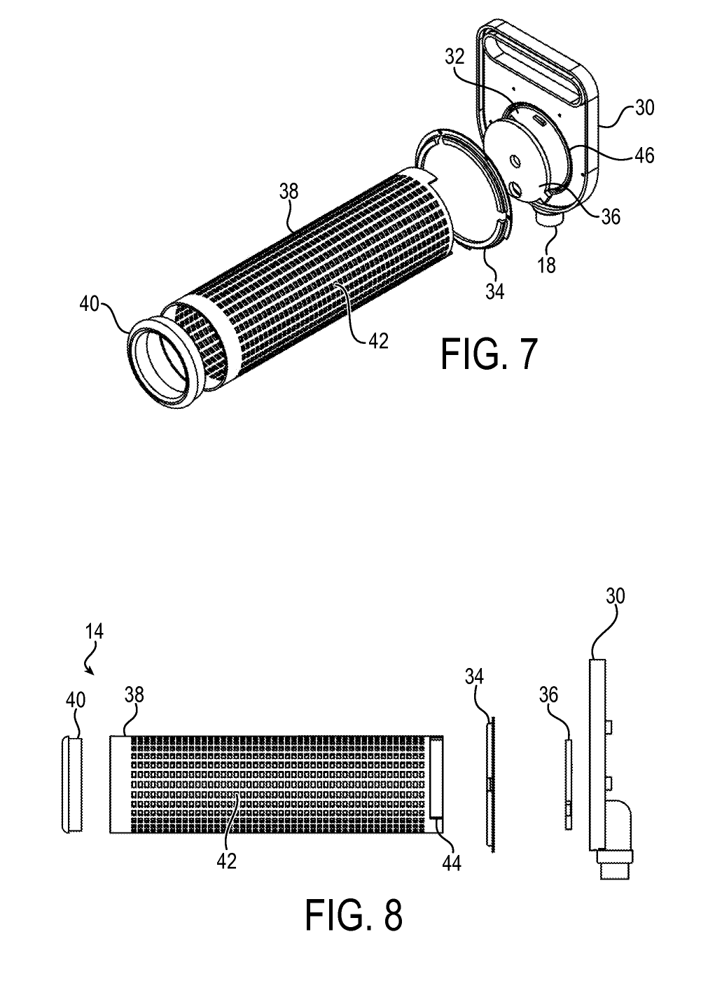

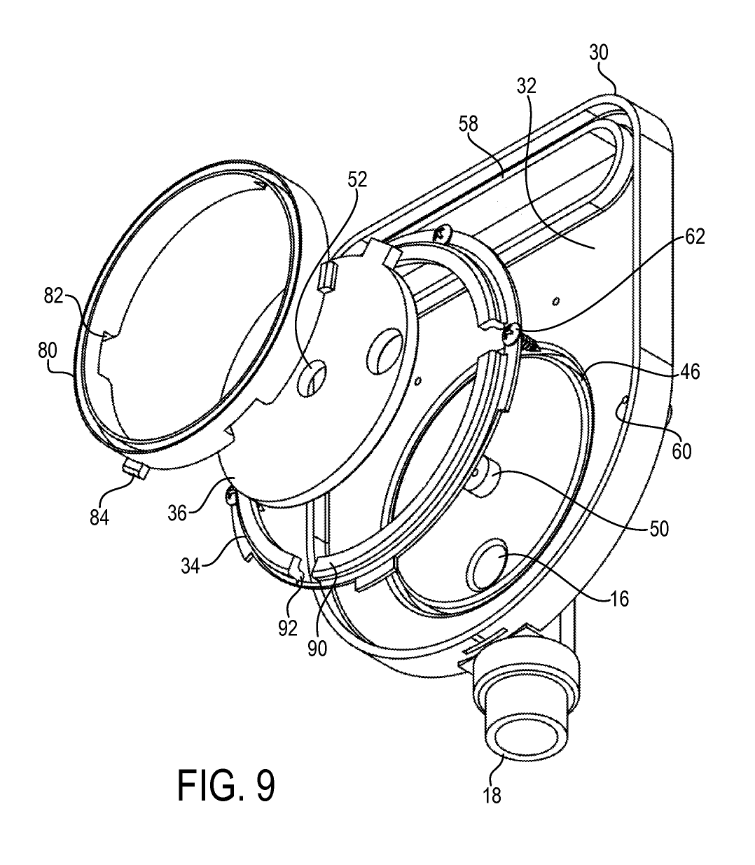

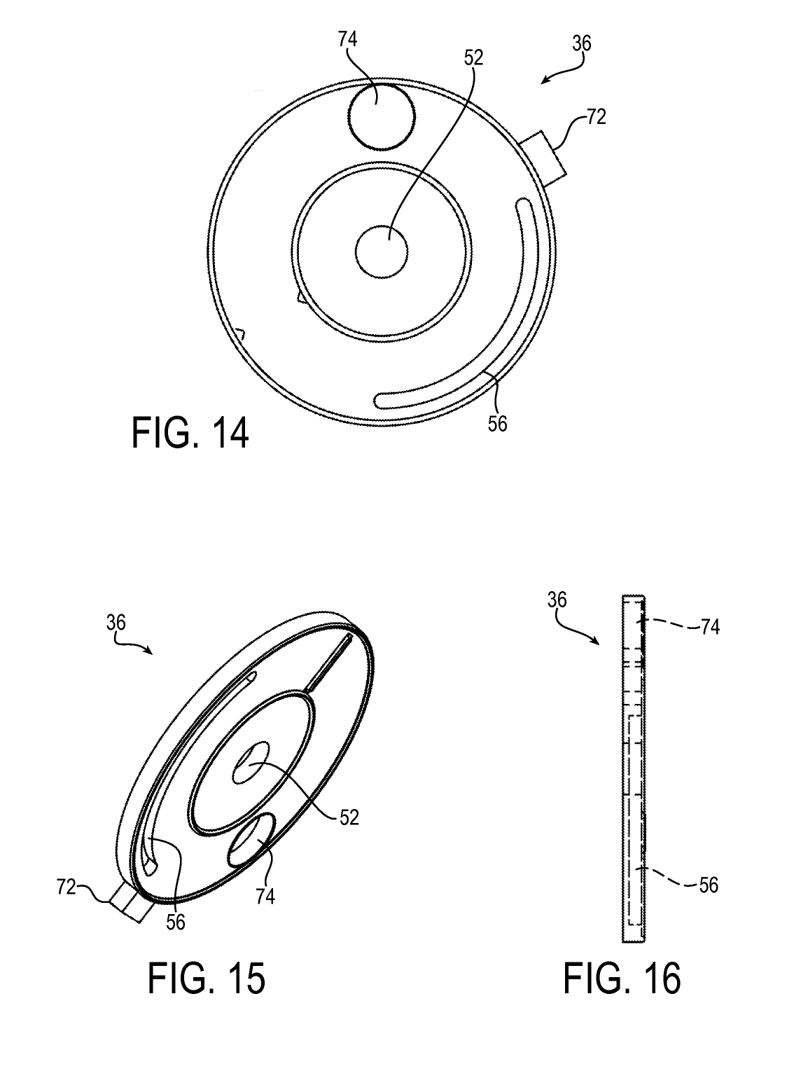

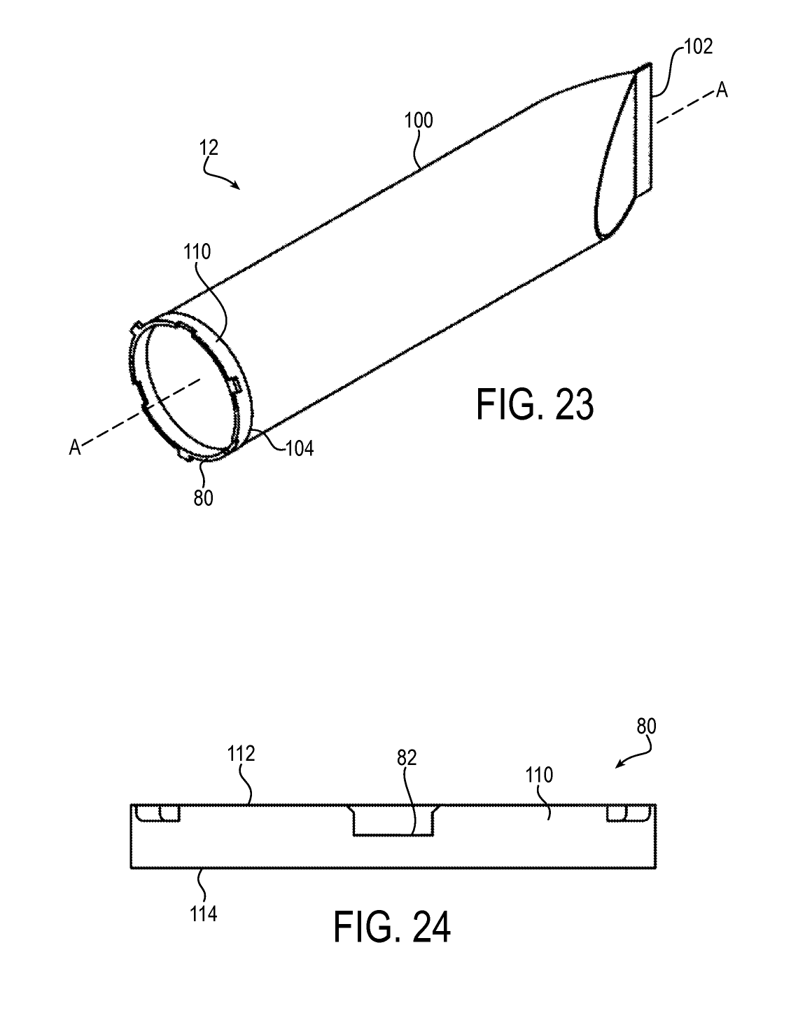

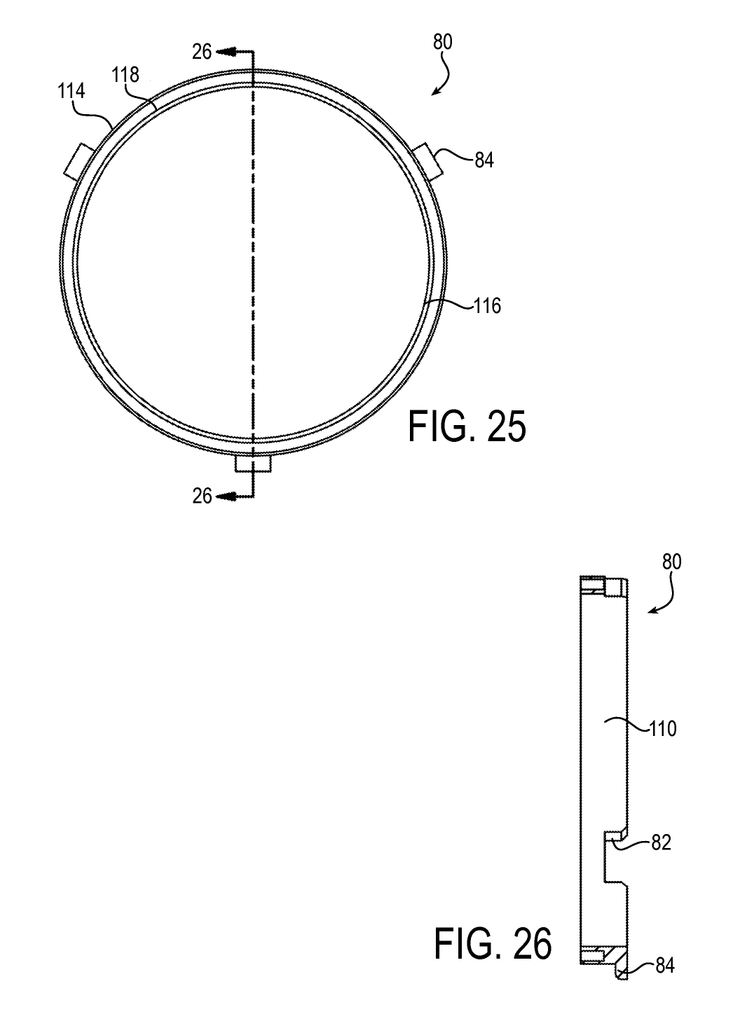

Referring to the drawings, and initially to FIGS. 1 and 2, an exemplary filter assembly is illustrated generally at reference numeral 10. The filter assembly 10 includes a filter 12, shown in detail in FIGS. 23-26 and discussed below, and a filter housing assembly 14 shown in detail in FIGS. 3-22 and discussed below. The filter 12 is connected to the filter housing assembly 14 to filter fluid, such as dirty water in a mop bucket. When the filter 12 requires cleaning or replacement, the filter 12 is disconnected from the filter housing assembly 14, which causes an inlet 16 (FIG. 9) of the filter housing assembly 14 to be blocked to prevent unfiltered fluid from flowing through the inlet 16 of the filter housing assembly to an outlet 18 of the filter housing assembly.

Turning now to FIGS. 3-8, the filter housing assembly 14 includes a housing 30 have the inlet 16 that opens to a mounting face 32 and the outlet 18 in fluidic communication with the inlet, a bag ring retainer 34 on the housing 30, and a driven cover 36 attached to the housing 30 at the mounting face 32 for movement relative to the housing 30. The assembly 14 may also include a support core 38 attached to the housing 30 at the mounting face 32 and an end plug 40 secured to an end of the support core 38 opposite the end attached to the housing 30. The support core 38 includes a plurality of openings 42 that allow water to flow from outside to support core 38 to an area inside the support core and a slot 44 at the end of the support core 38 that attaches to the housing 30. The end of the support core 38 with the slot 44 is received in an axially facing groove 46 in the mounting face 32 of the housing surrounding the inlet 16, and is attached to the housing 30 in any suitable manner.

Turning now to FIGS. 9 and 10, the housing 30 additionally includes an axially protruding portion 50 extending from the mounting face 32 that extends through an opening 52 of the driven cover 36, and a stop member 54 extending axially from the mounting face 32 for engaging a slot 56 (FIG. 15) in the driven cover 36. The driven cover 36 is attached to the protruding portion 50 and rotates about the protruding portion 50. The protruding portion 50 and stop member 54 are surrounded by the axially facing groove 46, and in the illustrated embodiment, the protruding portion 50 is centrally located relative to the axially facing groove 46. The housing 30 may also include a handle 58 to provide a user a hand hold, for example when removing/installing the filter assembly 10, and a plurality of mounting holes 60 for receiving fasteners, such as fasteners 62 to secure the bag ring retainer 34 to the housing 30. Additionally or alternatively, the bag ring retainer 34 may be secured to the housing 30 by adhesives, ultrasonic welding, heat fusion, etc.

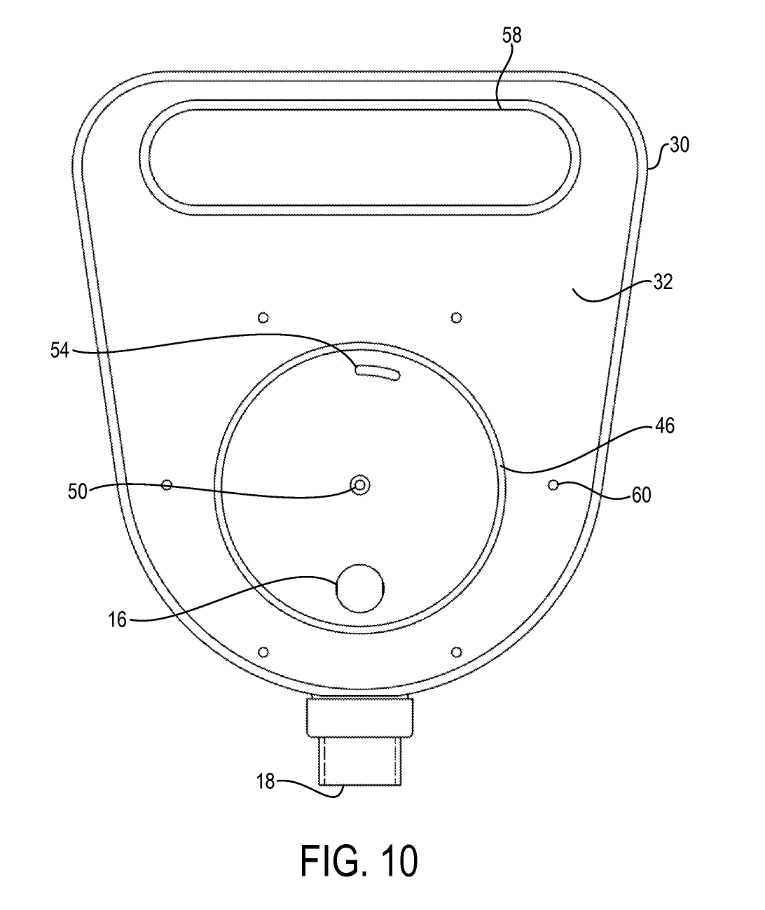

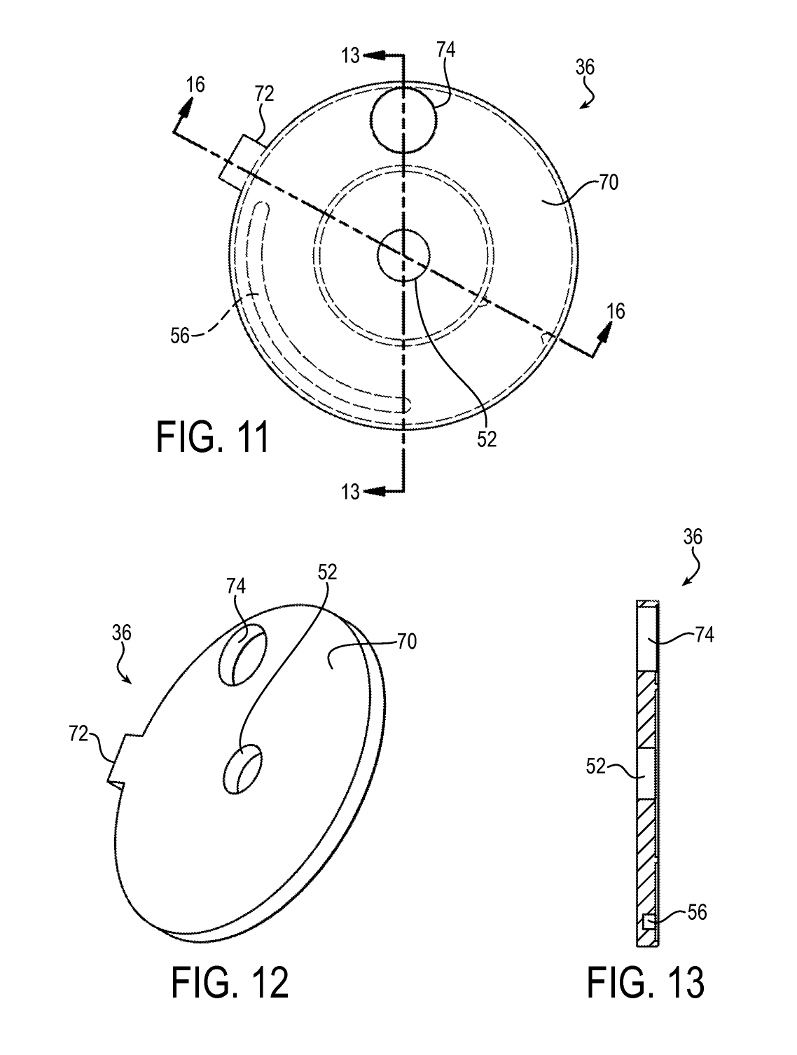

Turning now to FIGS. 11-16, the driven cover 36 includes a central body portion 70, at least one tab 72 projecting radially outwardly from the central body portion 70 for mating with a filter media ring 80 (FIG. 9), herein referred to as filter bag ring, in particular with at least one axially opening recess 82 (FIG. 9) of the filter bag ring 80, an aperture 74 in the central body portion 70, the opening 52 extending through the center of the central body portion 70, and the slot 56 in one side of the central body portion 70. The filter bag ring 80 moves the driven cover 36 relative to the housing 30 between a closed position covering the inlet 16 of the housing 30 and an open position uncovering the inlet 16 to allow flow into the inlet 16. When the driven cover 36 is in the closed position, the central body portion 70 covers the inlet 16 and when the driven cover 36 is in the open position, an aperture 74 in the central body portion 70 aligns with the inlet 16 to uncover the inlet.

As noted above, the driven cover 36 has a slot 56 that engages the stop member 54 of the housing 30. When the stop member 54 abuts one end of the slot 56, the driven cover 36 may be in the closed position, and when the stop member abuts the opposite end of the slot 56, the driven cover 36 may be in the closed position. In this way, over rotation of the driven cover 36 relative to the housing 30 is prevented.

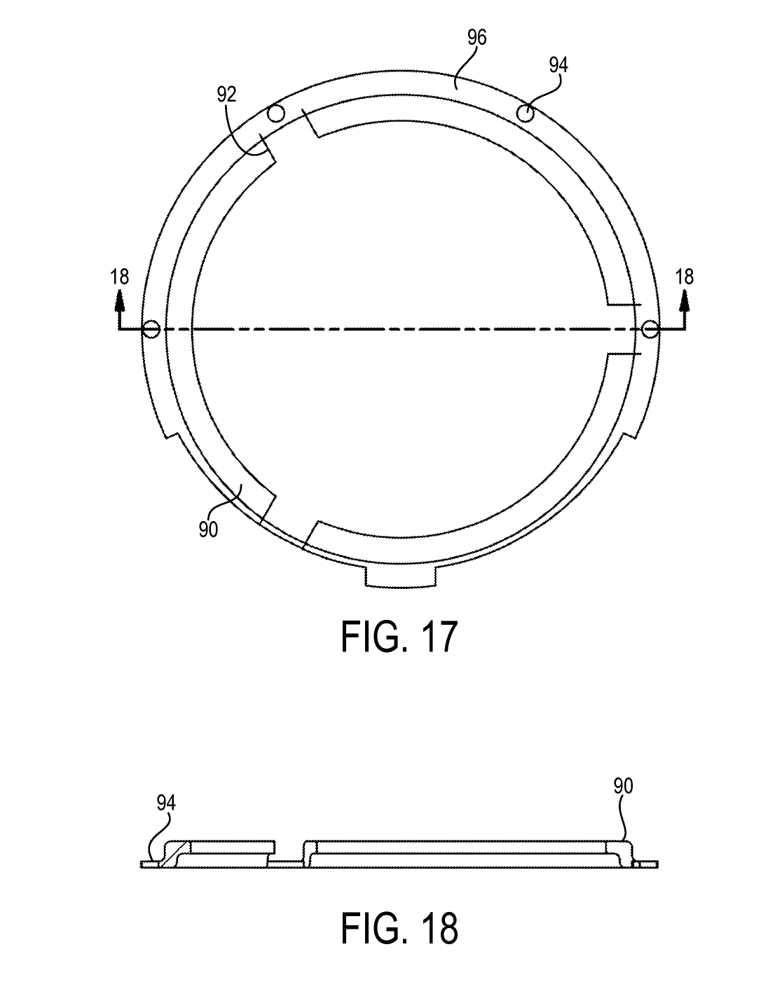

Turning now to FIGS. 17 and 18, the bag ring retainer or bayonet ring 34 includes a circumferential ledge 90 for axially retaining at least one tab 84 of the filter bag ring 80, at least one opening or groove 92 in the ledge for allowing axial insertion of the at least one tab 84 into the ledge 90 after which the filter bag ring 80 can be rotatable relative to the bag ring retainer 34 underneath the ledge 90 for locking the filter bag ring 80 to the bag ring retainer 34, and a plurality of openings 94 in a flange portion 96 of the bag ring retainer 34 through which the fasteners 62 extend to secure the bag ring retainer 34 to the housing 30. In the illustrated embodiment, the bag ring retainer 34 includes a plurality of circumferentially spaced openings 92 in the ledge 90 each configured to receive a respective tab 84 of the filter bag ring 80. The openings 92 in the ledge 90 may be spaced in any suitable manner, such as equally spaced to allow any tab 84 to be received in any of the openings 92. When the bag ring retainer 34 is secure to the housing 30, the bag ring retainer will surround the axially facing groove 46 and the driven cover 36

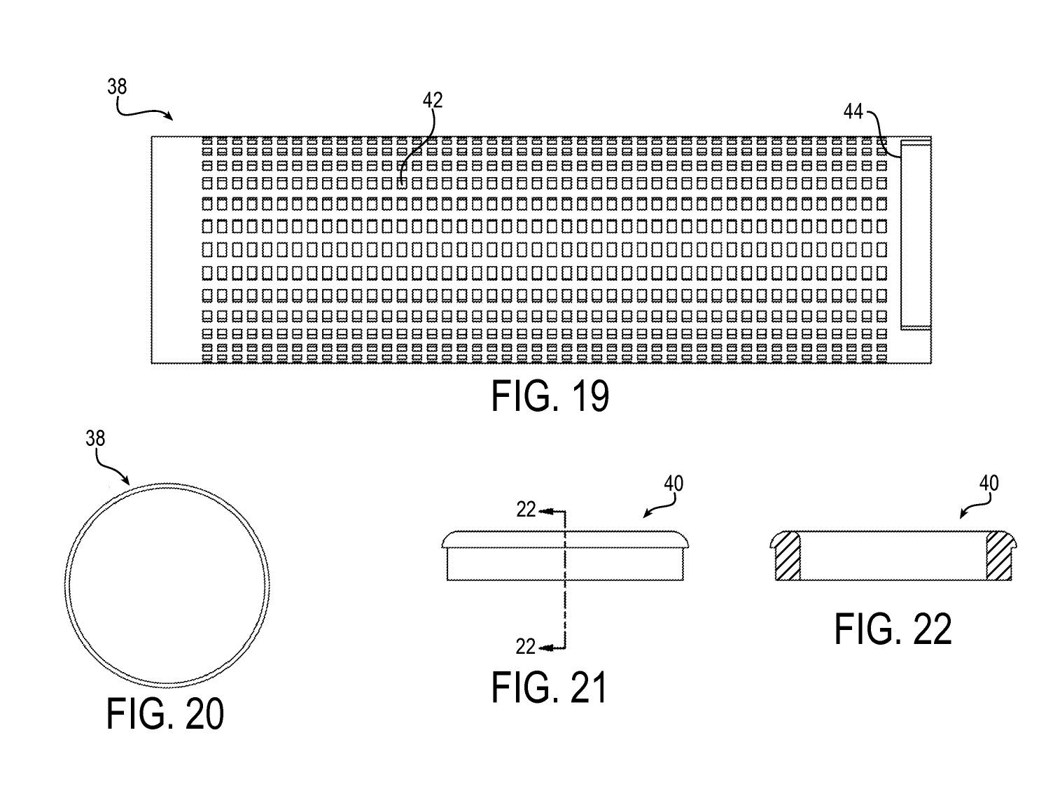

Turning now to FIGS. 19 and 20, the support core 38 includes the plurality of openings 42 that extend around the support core 38 and substantially along the length of the support core for water to flow through, and the slot 44 at the end of the support core 38 received in the axially facing groove 46. The support core 38 surrounds the central body portion 70 of the driven cover 36 and is sized such that the tab 72 of the drive cover 36 extends through the slot 44. The driven cover 36 moves relative to the slot 44 between the open and closed positions. It will be appreciated that the support core 38 may be sized to be larger in diameter than the diameter of the support core 38 and the length of the tab 72.

Turning now to FIGS. 21 and 22, the end plug 40 may be secured to the end of the support core 38 opposite the end attached to the housing 30 in any suitable manner, such as by an adhesive or welding. Alternatively, the end plug 40 may be integrally formed with the support core 38. The end plug 40 includes a through passage extending along its length to allow water flowing through the filter 12 to flow into the support core 38 to flow towards the inlet 16.

Turning now to FIGS. 23-26, the filter 12 includes the filter bag ring 80 and a filter media 100 circumscribing a central axis A-A and attached to the filter bag ring 80. The filter media 100 may be any suitable media, such as a filter bag formed from a woven or non-woven material, which may be formed in any suitable manner, such as by forming the filter as a tubular structure having open ends by rolling a sheet of media and attaching the sides in any suitable manner, such as by adhesives, ultrasonic welding, heat fusion, etc. One of the ends of the filter bag 100 may then be closed, as shown at 102, in any suitable manner, such as by sealing the end using adhesive, ultrasonic welding, heat fusion, etc., or may otherwise be blocked by a suitable plug, and the other end 104 may remain open and be attached to the filter bag ring 80 in any suitable manner, such as by an adhesive, ultrasonic welding, heat fusion, etc. Alternatively, the filter media 100 may be a pleated media, such as a pleated non-woven media, a tubular melt blown media, etc., which is formed in any suitable manner. The filter media 100 may be a reusable filter that does not require daily back flushing, thereby saving time and water.

The filter bag ring 80 includes a central body portion 110 having a first axial side 112, a second axial side 114 opposite the first axial side 112, and an opening 116 extending therethrough, the at least one tab 84 projecting radially outwardly from the central body portion 110 proximate the first axial side 112 for mating with the tab 72 of the driven cover 36, and the at least one axially opening recess 82 in the first axial side 112. The central body portion 110 may include an axially opening channel 118 in the second axial side 114 for receiving the open end 104 of the filter bag 100, and the central body portion may be u-shaped in cross-section to define the axially opening channel 118.

In the illustrated embodiment, the at least one tab 84 of the filter bag ring 80 includes a plurality of circumferentially spaced tabs 84 projecting radially outwardly from the periphery of the central body portion 110, and the at least one axially opening recess 82 includes a plurality of circumferentially spaced axially opening recesses 82 in the first axial side 112 of the central body portion 110. When the filter bag ring 80 is connected to the bag ring retainer 34, one of the plurality of circumferentially spaced axially opening recesses 82 will be engaged with the tab 72 of the driven cover 36. The plurality of circumferentially spaced tabs 84 may be offset from the plurality of axially opening recesses 82, and in the illustrated embodiment, are alternately spaced around the central body portion 110. The plurality of circumferentially spaced tabs 84 may be integrally formed with the central body portion 110, or the tabs 84 may be coupled to the central body portion 110 in any suitable manner.

When the filter 12 is disconnected from the filter housing assembly 14, for example when the filter is being replaced, the driven cover 36 is in the closed position where the central body portion 70 of the driven cover 36 covers the inlet 16 of the housing 30 to prevent unfiltered fluid from exiting the filter housing assembly 14. To connect the filter 12 to the filter housing assembly 14, the filter 12 is advanced towards the housing 30 such that the filter bag ring 80 and the filter bag 100 surround the support core 38 and end plug 40. As the filter 12 is advanced towards the housing 30, the plurality of circumferentially spaced tabs 84 of the filter bag ring 80 are aligned with the plurality of circumferentially spaced openings 92 in the circumferential ledge 90 of the bag ring retainer 34. The plurality of circumferentially spaced tabs 84 are then advanced axially through the respective plurality of circumferentially spaced openings 92 and the filter bag ring 80 is rotated underneath the circumferential ledge 90 to lock the filter bag ring 80 to the bag ring retainer 34.

As the tabs of the filter bag ring 80 are advanced axially through the openings 92 in the bag ring retainer 80, one of the plurality of circumferentially spaced axially opening recesses 82 will engage the tab 72 of the driven cover 36 such that the tab is disposed in one of the recesses 82. Alternatively, it will be appreciated that the filter bag ring 80 may be advanced axially through the openings 92 and then rotated, and during rotation the tab 72 may engage one of the circumferentially spaced axially opening recesses 82.

When the filter bag ring 80 is rotated relative to the bag ring retainer 34, such as rotated clockwise, the rotation of the filter bag ring 80 rotates the driven cover 36 from the closed position towards the open position. The driven cover 36 is rotated relative to the housing 30 such that the stop member 54 goes from abutting one end of the slot 56 to the opposite end of the slot 56. When the stop member 43 abuts the opposite end of the slot 56, the driven cover 34 will be in the open position where the aperture 74 in the central body portion 70 of the driven cover 34 is aligned with the inlet 16.

Once the inlet 16 has been uncovered by the central body portion 70, fluid outside the filter bag 100, for example water in a dirty water chamber of a mop bucket, flows through the filter bag 100 where particulates are separated from the fluid. The fluid then flows through the openings 42 in the support core 38 towards the housing 30, where the fluid flows through the aperture 74 and inlet 16 to the outlet 18 that may be fluidly connected to, for example, a clean water chamber of a mop bucket. When it is desired to replace or clean the filter 12, the filter 12 will be rotated, for example counter clockwise, thereby moving the driven cover 36 back to the closed position. The filter 12 is rotated until the plurality of circumferentially spaced tabs 84 are aligned with the respective plurality of circumferentially spaced openings 92 in the filter bag ring 34, and then the filter 12 is axially removed from the filter housing assembly 14.

Although described for use in mop buckets, it will be appreciated that the filter assembly may be used in any suitable filtration application, such as in a tank type application, such as a gravity feed tank where the filter is provided as a downstream drain filter inside or outside the tank.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A filter assembly including:
a filter including:
a filter media circumscribing a central axis and having a closed end and an open end; and
a filter media ring attached to the filter media at the open end, the filter media ring including a central body portion having a first axial side, a second axial side opposite the first axial side, and an opening extending therethrough, at least one tab projecting radially outwardly from the central body portion, and at least one axially opening recess in the first axial side; and
a filter housing assembly including:
a housing having an inlet opening to a mounting face and an outlet in fluidic communication with the inlet;
a media ring retainer on the housing including a circumferential ledge for axially retaining the at least one tab of the filter media ring, and at least one opening in the ledge for allowing axial insertion of the at least one tab into the ledge after which the filter media ring is rotatable relative to the media ring retainer for locking the filter media ring to the media ring retainer; and
a driven cover attached to the housing at the mounting face for movement relative to the housing between a closed position covering the inlet of the housing and an open position uncovering the inlet to allow flow into the inlet, the driven cover including a central body portion and at least one tab projecting radially outwardly from the central body portion for mating with the at least one axially opening recess of the filter media ring to be moved by the filter media ring between the open and closed positions.

2. The filter assembly according to claim 1, wherein the at least one tab of the filter media ring includes a plurality of circumferentially spaced tabs projecting radially outwardly from the periphery of the central body portion.

3. The filter assembly according to claim 2, wherein the plurality of circumferentially spaced tabs are offset from the at least one axially opening recess.

4. The filter assembly according to claim 1, wherein the at least one axially opening recess includes a plurality of circumferentially spaced axially opening recesses in the first axial side.

5. The filter assembly according to claim 1, wherein the central body portion of the filter media ring includes an axially opening channel in the second side for receiving the open end of the filter media.

6. The filter assembly according to claim 5, wherein the central body portion of the filter media ring is u-shaped in cross-section to define the axially opening channel.

7. The filter assembly according to claim 1, wherein the driven cover has a surface slidably engaged with a corresponding surface on the housing.

8. The filter assembly according to claim 7, wherein the surface of the driven cover has a slot and the corresponding surface of the housing is a stop member.

9. The filter assembly according to claim 1, wherein the driven cover includes an aperture that aligns with the inlet when the driven cover is in the open position.

10. The filter assembly according to claim 1, wherein the housing includes an axially protruding portion and the central body portion of the driven cover has an opening extending therethrough through which the protruding portion extends to attach the driven cover to the housing.

11. The filter assembly according to claim 1, wherein the at least one opening in the ledge includes a plurality of circumferentially spaced openings in the ledge.

12. The filter assembly according to claim 1, further including a support core attached to the housing at the mounting face.

13. The filter assembly according to claim 12, wherein the housing further includes an axially facing groove surrounding the inlet, and wherein an end of the support core is received in the axially facing groove to attach the support core to the housing.

14. The filter assembly according to claim 12, wherein the support core includes a slot through which the tab of the driven cover moves.

15. The filter assembly according to claim 12, further including an end plug secured an end of the support core opposite the end secured to the housing.

16. The filter assembly according to claim 1, wherein the filter media is a filter bag.

17. A filter housing assembly connectable to a filter that includes a filter media and a filter media ring attached to the filter media, the filter media ring having at least one radially outwardly projecting tab and at least one axially opening recess, the filter housing assembly including:
a housing have an inlet opening to a mounting face and an outlet in fluidic communication with the inlet;
a media ring retainer on the housing including a circumferential ledge for axially retaining the at least one tab of the filter media ring and at least one opening in the ledge for allowing axial insertion of the at least one tab into the ledge after which the media ring is rotatable relative to the retainer for locking the media ring to the retainer; and
a driven cover attached to the housing at the mounting face for movement relative to the housing between a closed position covering the inlet of the housing and an open position uncovering the inlet to allow flow into the inlet, the driven cover including a central body portion and at least one tab projecting radially outwardly from the central body portion for mating with the at least one recess of the filter media ring.

18. The filter housing assembly according to claim 17, wherein the driven cover has a surface slidably engaged with a corresponding surface on the housing.

19. The filter housing assembly according to claim 18, wherein the surface of the driven cover has a slot and the corresponding surface of the housing is a stop member.

20. The filter housing assembly according to claim 1, wherein the driven cover includes an aperture that aligns with the inlet when the driven cover is in the open position.

21. The filter housing assembly according to claim 1, wherein the housing includes an axially protruding portion and the central body portion has an opening extending therethrough through which the protruding portion extends to attach the driven cover to the housing.

22. The filter housing assembly according to claim 1, wherein the at least one opening in the ledge includes a plurality of circumferentially spaced openings in the ledge.

23. The filter housing assembly according to claim 1, further including a support core attached to the housing at the mounting face.

24. The filter housing assembly according to claim 23, wherein the housing further includes an axially facing groove surrounding the inlet 16, and wherein an end of the support core is received in the axially facing groove to attach the support core to the housing.

25. The filter housing assembly according to claim 23, wherein the support core includes a slot through which the tab moves.

26. The filter housing assembly according to claim 23, further including an end plug secured an end of the support core 38-opposite the end secured to the housing.

27. A filter for use in a filter assembly, the filter including:
a filter bag circumscribing a central axis and having a closed end and an open end; and
a filter bag ring attached to the filter bag at the open end, the filter bag ring including a central body portion having a first axial side, a second axial side opposite the first axial side, and an opening extending therethrough from the first axial side to the second axial side, at least one tab projecting radially outwardly from the central body portion and having a circumferential length less than a circumferential length of a periphery of the central body portion, and at least one axially opening recess in the first axial side for engaging a tab of a driven cover to move the driven cover to an open position allowing fluid flow through the filter assembly.

28. The filter according to claim 27, wherein the at least one tab includes a plurality of circumferentially spaced tabs projecting radially outwardly from the periphery of the central body portion.

29. The filter according to claim 27, wherein the plurality of circumferentially spaced tabs are offset from the at least one axially opening recess.

30. The filter according to claim 1, wherein the at least one axially opening recess includes a plurality of circumferentially spaced axially opening recesses in the first axial side.

31. The filter according to claim 1, wherein the central body portion includes an axially opening channel in the second side for receiving the open end of the filter bag.

32. The filter according to claim 31, wherein the central body portion is u-shaped in cross-section to define the axially opening channel.

33. A method of installing a filter on a filter housing assembly, the filter including a filter bag and a filter bag ring attached to an open end of the filter bag, and the filter housing assembly including a housing having an inlet, a bag retainer attached to the housing, a driven cover attached to the housing for movement relative to the housing, and a support core attached to the housing, the method including:
advancing the open end of the filter bag over the support core;
aligning a plurality of circumferentially spaced tabs of the filter bag ring with a plurality of circumferentially spaced openings in a circumferential ledge of the bag ring retainer;
advancing the plurality of circumferentially spaced tabs through the plurality of circumferentially spaced openings; and
rotating the filter to a locked position thereby moving the driven cover to an open position to uncover the inlet in the housing to allow fluid flow through the inlet.

34. The method according to claim 33, wherein the driven cover includes an aperture that aligns with the inlet when the driven cover is in the open position.

35. The method according to claim 33, wherein when the filter is rotated, a tab projecting from the driven cover mates with an axially opening recess in the filter bag ring such that rotation of the filter moves the driven cover to the open position.

36. A filter 12 for use in a filter assembly, the filter including:
a cylindrical ring with inner and outer cylindrical surfaces extending between first and second axial end faces, a plurality of circumferentially spaced tabs projecting radially outwardly from the outer cylindrical surface proximate the first axial end face, and a plurality of circumferentially spaced notches in the first axial end face; and
a filter bag attached to the cylindrical ring and extending from the second axial end face.

37. A filter housing assembly including:
a housing having a passage;
a bayonet member defining a ledge and having at least one groove for axially receiving a tab of a filter media member to allow for insertion of the tab and rotation of the tab underneath the ledge; and
a valve member having a coupling feature for coupling with a mating coupling feature on the filter media member such that rotation of the filter media member causes rotation of the valve member,
wherein the valve member is rotatable between an open position allowing flow through the passage in the housing and a closed position blocking flow to the passage.
